(19) United States
(12) Patent Application Publication
(10) Pub. No.: US 2021/0337105 A1
(43) Pub. Date: Oct. 28, 2021

(54) PHOTOGRAPHING METHOD FOR AIRCRAFT, AIRCRAFT, TERMINAL DEVICE AND FLIGHT SYSTEM

(71) Applicant: AUTEL ROBOTICS CO., LTD., Shenzhen (CN)

(72) Inventor: Chuanlun HU, Shenzhen (CN)

(21) Appl. No.: 17/369,140

(22) Filed: Jul. 7, 2021

Related U.S. Application Data
(63) Continuation of application No. PCT/CN2020/070479, filed on Jan. 6, 2020.

(30) Foreign Application Priority Data
Jan. 7, 2019 (CN) 201910011672.5

(51) Int. Cl. H04N 5/232; H04N 7/18; H04N 5/262

(52) U.S. Cl. CPC H04N 5/23203; H04N 5/232935; G05D 1/0016; H04N 5/2621; H04N 7/185

(57) ABSTRACT

The embodiments are a photographing method for an aircraft, an aircraft, a terminal device and a flight system. The photographing method is applicable to an aircraft. The aircraft includes a camera apparatus. The camera apparatus includes a camera and a dimming assembly. The dimming assembly is configured to adjust light entering the camera. The photographing method includes: controlling the camera apparatus to collect an image; transmitting the image to the terminal device to display the image on the terminal device, the terminal device being communicatively connected to the aircraft; detecting whether an instruction transmitted by the terminal device is received, the instruction being generated according to an operation performed by a user on the terminal device; and adjusting the dimming assembly according to the instruction to change the light entering the camera, so as to adjust the image, if the instruction is received.

### CROSS REFERENCE

This application is a continuation of International Application No. PCT/CN2020/070479, filed on Jan. 6, 2020, which claims priority to Chinese Patent Application No. 2019100116725 filed on Jan. 7, 2019, which is incorporated herein by reference in its entirety.

### BACKGROUND

### Technical Field

The present invention relates to the technical field of image acquisition, and in particular, to a photographing method for an aircraft, an aircraft, a terminal device, and a flight system.

### Related Art

As rotor unmanned aerial vehicles (UAVs) develop rapidly, photographing by using aircrafts becomes popular with people. However, during photographing by using the aircraft, a camera apparatus of the aircraft may fail to obtain desirable image information or video information as a result of environmental factors such as sunlight, shadows and the like.

### SUMMARY

In order to overcome the shortcomings of the prior art, a purpose of the present invention is to provide a photographing method for an aircraft, an aircraft, a terminal device, and a flight system.

The purpose of the present invention is implemented by using the following technical solutions. A photographing method for an aircraft is provided, which is applicable to an aircraft. The aircraft includes a camera apparatus. The camera apparatus includes a camera and a dimming assembly. The dimming assembly is configured to adjust light entering the camera. The photographing method includes: controlling the camera apparatus to collect an image; transmitting the image to the terminal device, to display the image on the terminal device, the terminal device being communicatively connected to the aircraft; detecting whether an instruction transmitted by the terminal device is received, the instruction being generated according to an operation performed by a user on the terminal device; and adjusting the dimming assembly according to the instruction to change the light entering the camera, so as to adjust the image, if the instruction is received.

Preferably, the instruction includes an adjustment instruction to adjust the dimming assembly, and the dimming assembly includes a dimmer and a driver configured to drive the dimmer to rotate relative to the camera. The adjusting the dimming assembly according to the instruction to change the light entering the camera, so as to adjust the image further includes: controlling the driver to drive the dimmer to rotate relative to the camera by a preset angle, if the adjustment instruction transmitted by the terminal device is received.

Preferably, the controlling the driver to drive the dimmer to rotate relative to the camera by a preset angle further includes: outputting a pulse signal to the driver to control the driver to rotate according to the pulse signal and rotate the dimmer by the preset angle.

Preferably, the adjustment instruction is a pulse setting instruction, and the photographing method further includes: acquiring a pulse setting instruction transmitted from the terminal device; and adjusting a frequency of the outputted pulse signal according to the pulse setting instruction to control the outputted pulse signal.

Preferably, the instruction includes a photographing instruction, and the method further includes: transmitting the image adjusted by the dimming assembly to the terminal device; transmitting a prompt to the terminal device, the prompt being used for prompting the user to confirm an image effect; and controlling, according to the photographing instruction, the camera apparatus to perform photographing to generate a photo or a video, if the aircraft receives user confirmation information transmitted by the terminal device.

The present invention further provides a photographing method, applicable to a terminal device. The terminal device is configured to control an aircraft and is communicatively connected to the aircraft. The photographing method includes: acquiring an image collected by a camera apparatus of the aircraft, and displaying the image, the camera apparatus including a camera and a dimming assembly; and transmitting an instruction to the aircraft, to control the aircraft to adjust the dimming assembly, to change light entering the camera, so as to adjust the image.

Preferably, the instruction includes an adjustment instruction to adjust the dimming assembly, and the dimming assembly includes a dimmer and a driver configured to drive the dimmer to rotate relative to the camera; and the transmitting an instruction to the aircraft to control the aircraft to adjust the dimming assembly to change light entering the camera, so as to adjust the image includes: transmitting the instruction to the aircraft to control the driver to drive the dimmer to rotate relative to the camera by a preset angle.

Preferably, the transmitting the instruction to the aircraft to control the driver to drive the dimmer to rotate relative to the camera by a preset angle includes: controlling the aircraft to output a pulse signal to the driver to control the driver to rotate according to the pulse signal and rotate the dimmer by the preset angle.

Preferably, the adjustment instruction is a pulse setting instruction, and the photographing method further includes: transmitting the pulse setting instruction to the aircraft, so that the aircraft adjusts a frequency of the outputted pulse signal according to the pulse setting instruction to control the outputted pulse signal.

Preferably, the photographing method further includes: acquiring the image adjusted by the dimming assembly; prompting a user to confirm an image effect; and controlling the aircraft to control, according to the photographing instruction, the camera apparatus to perform photographing to generate a photo or a video, if the user confirms the image effect.

The present invention further provides an aircraft. The aircraft is communicatively connected to a terminal device. The aircraft includes: a camera apparatus, including a camera configured to collect an image and a dimming assembly configured to adjust light entering the camera; a signal transceiver, configured to receive an instruction from the terminal device; a memory, configured to store a computer-executable photographing method program; and a processor, configured to invoke the computer-executable photographing method program to perform the foregoing photographing method.

The present invention further provides a terminal device. The terminal device is communicatively connected to an aircraft. The aircraft includes a camera apparatus and a dimming assembly. The camera apparatus includes a camera configured to collect an image, and the dimming assembly is configured to adjust light entering the camera. The terminal device includes: a display, configured to display the image collected by the aircraft; an input apparatus, configured to transmit an instruction to the aircraft to control the aircraft to adjust the dimming assembly to change the light entering the camera, so as to adjust the image; a memory, configured to store a computer-executable photographing method program; and a processor, configured to invoke the computer-executable photographing method program to perform the foregoing photographing method.

The present invention further provides a flight system. The flight system includes a terminal device and an aircraft communicatively connected to the terminal device. The aircraft includes: a camera apparatus, including a camera configured to collect an image and a dimming assembly configured to adjust light entering the camera; a signal transceiver, configured to receive an instruction from the terminal device; a memory, configured to store a computer-executable photographing method program; and a processor, configured to invoke the computer-executable photographing method program to perform the foregoing photographing method.

Compared with the prior art, according to the photographing method for an aircraft, the aircraft, the terminal device and the flight system provided in the present invention, the user determines whether the acquired image satisfies the requirements by using the terminal device, and controls, by using the input apparatus, the dimming assembly to be controlled to change the light entering the camera, when the acquired image does not satisfy the requirements, so as to obtain an image satisfying the requirements.

### BRIEF DESCRIPTION OF THE DRAWINGS

FIG. 1 is a schematic diagram of application of a photographing method for an aircraft to a flight system according to the present invention.

FIG. 2 is a structural block diagram of a terminal device.

FIG. 3 is a schematic structural diagram of engagement between a dimming assembly and a camera apparatus of an aircraft.

FIG. 4 is a structural block diagram of a main body of the aircraft.

FIG. 5 is a flowchart of a photographing method for an aircraft according to an embodiment of the present invention.

FIG. 6 is a flowchart of a photographing method for an aircraft according to an embodiment of the present invention.

FIG. 7 is a flowchart of a photographing method for an aircraft according to an embodiment of the present invention.

FIG. 8 is a flowchart of a photographing method for an aircraft according to an embodiment of the present invention.

### DETAILED DESCRIPTION

The present invention is further described below with reference to drawings and specific implementations. It should be noted that, the following embodiments or technical features may be arbitrarily combined into new embodiments in case of no conflicts.

The present invention provides a photographing method for an aircraft, an aircraft, a terminal device and a flight system. The aircraft acquires an image by using a camera of the camera apparatus and transmits the image to the terminal device, to display the image on the terminal device, so that a user may determine, according to the terminal device, whether the acquired image satisfies requirements. When the acquired image does not satisfy the requirements, an adjustment instruction is transmitted to the camera apparatus by using an input apparatus, to control a dimming assembly to be adjusted, so as to change light entering the camera, thereby obtaining an image satisfying the requirements.

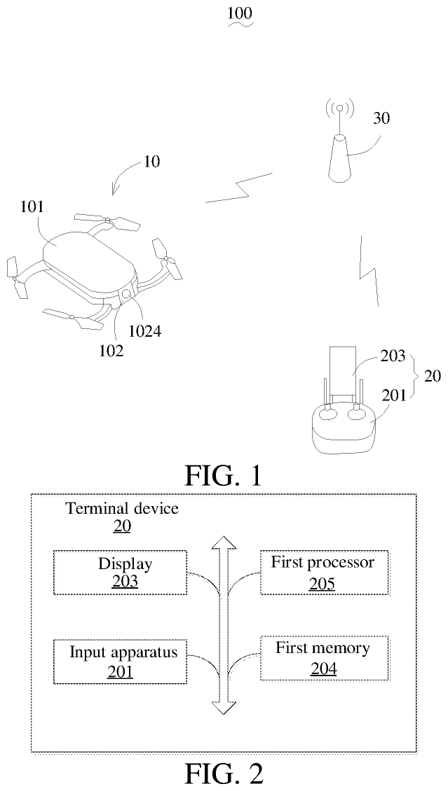

Referring to FIG. 1 to FIG. 2, the flight system 100 includes an aircraft 10 and a terminal device 20. The terminal device 20 is communicatively connected to the aircraft 10 by using a ground station 30 and is configured to control the aircraft 10.

The terminal device 20 includes a display 203, an input apparatus 201, a first memory 204 and a first processor 205. The display 203 is configured to display an image collected by using a camera 1021. The input apparatus 201 is configured to transmit an instruction to a camera apparatus 202. The instruction includes an adjustment instruction and a photographing instruction. The adjustment instruction is an instruction to control a dimming assembly 1024 to rotate relative to the camera 1021, and the photographing instruction is an instruction to control the camera apparatus 102 to take a picture or record a video.

The first memory 204 is configured to store a computer-executable program therein. The first processor 205 invokes the computer-executable program stored in the first memory 204 to perform the photographing method for an aircraft.

The first processor 205 is a control center of the terminal device 20, which is connected to various parts of the entire terminal device 20 by using various interfaces and lines, and runs or executes programs and/or units stored in the first memory 204 to invoke the computer-executable program stored in the first memory 204, so as to perform various functions of the terminal device 20 and process data.

The aircraft 10 includes a host 101 and the camera apparatus 102 mounted on the host 101. The host 101 is a main body of the aircraft 10 to achieve a flight function. The camera apparatus 102 has the camera 1021 (see FIG. 2) and the dimming assembly 1024 disposed thereon. The camera 1021 is configured to collect an image, and the dimming assembly 1024 is configured to adjust light entering the camera 1021, to adjust a photographing effect of the camera 1201.

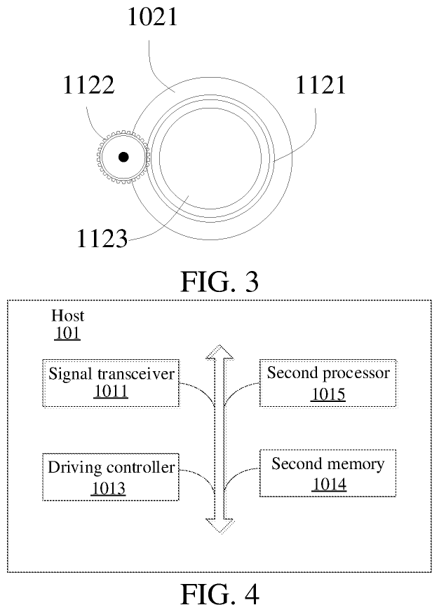

Referring to FIG. 3, the dimming assembly 1024 includes a fixing frame 1121, a driver 1122 and a dimmer 1123. The fixing frame 1121 is disposed at a front end of the camera 1021, and the dimmer 1123 is mounted on the fixing frame 1121 and shields the camera 1021 from the front. The driver 1122 is fixed to the host 101 and meshes with the dimmer 1123 to drive the dimmer 1121 to rotate relative to the camera 1021. The dimmer 1123 has a dimming sheet disposed therein. By rotating the dimming sheet, the light entering the camera 1021 can be adjusted. Preferably, the dimming sheet is a polarizing filter.

Referring to FIG. 4, the aircraft 10 further has a signal transceiver 1011 and a driving controller 1013 disposed thereon.

The signal transceiver 1011 is mounted on the host 1011. The signal transceiver 1011 is configured to receive a control instruction transmitted by the terminal device 20 and transmit the image obtained by the camera apparatus 102 to the terminal device 20, so as to display, on the terminal device 20, the image acquired by the camera apparatus 102.

The driving controller 1013 is mounted on the host 1011 and is configured to control the dimming assembly 1121 to rotate relative to the camera 1021. When the instruction transmitted by the terminal device 20 is an adjustment instruction, the aircraft 10 transmits the adjustment instruction to the driving controller 1013. The driving controller 1013 generates a driving control signal according to the adjustment instruction to drive the driver 1122, and drives, by using the driver 1122, the dimmer 1123 to rotate relative to the camera 1021, so as to change the light entering the camera 1021. When the instruction transmitted by the terminal device 20 is a photographing instruction, the aircraft 10 controls the camera apparatus 102 to perform photographing to generate a photo or a video.

In some embodiments, the host 101 further has a second memory 1014 and a second processor 1015 disposed therein. The second memory 1014 is configured to store a computer-executable program. The second processor 1015 invokes the computer-executable program stored in the second memory 1014 to perform the photographing method for an aircraft.

The second processor 1015 is a control center of the aircraft 10, which is connected to various parts of the entire aircraft 10 by using various interfaces and lines, and runs or executes programs and/or units stored in the second memory 1014 to invoke the computer-executable program stored in the second memory 1014, so as to perform various functions of the aircraft 10 and process data.

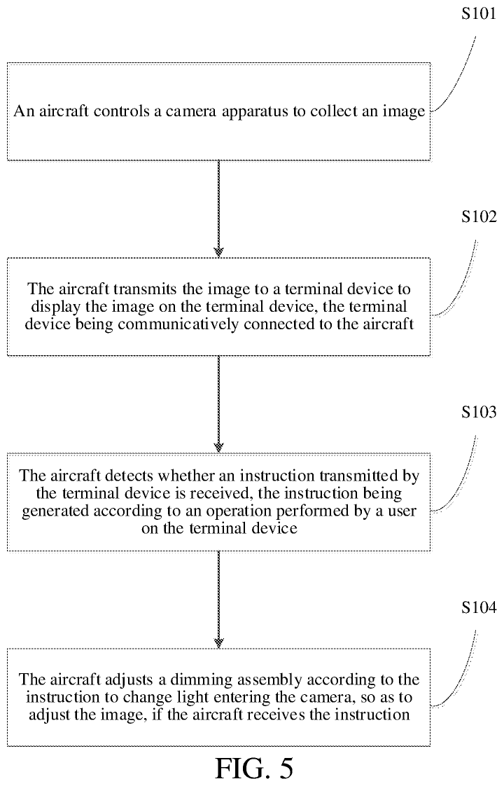

FIG. 5 is a photographing method for an aircraft according to an embodiment of the present invention. The photographing method is applicable to the aircraft 10. A computer-executable program corresponding to the photographing method may be stored in the second memory 1014 of the aircraft 10. When the second processor 1015 of the aircraft 10 invokes the program of the photographing method, the photographing method is performed.

Referring to FIG. 5, the photographing method includes the following steps S101-S104:

Step S101: Control the camera apparatus to collect an image.

When a user wants to obtain image information of a specific area by using the aircraft 10, the aircraft 10 is controlled by using the input apparatus 201 of the terminal device 20 to fly over the area, and a control instruction indicating turn-on of the camera apparatus 102 is transmitted to the aircraft 10 by using the input apparatus 201, to control the camera 1021 of the camera apparatus 102 to collect an image of the area. The image is an image acquired by the camera 1021 of the camera apparatus 102 in real time.

Step S102: Transmit the image to the terminal device, to display the image on the terminal device, the terminal device being communicatively connected to the aircraft.

The aircraft 10 establishes a communicative connection to the terminal device 20. In some embodiments, specifically, the aircraft 10 transmits a communicative connection establishment request to the terminal device 10, the terminal device 20 returns a communicative connection response when receiving the communicative connection request, and the aircraft 10 establishes a communicative connection to the terminal device 20 when receiving the communicative connection response.

In some embodiments, alternatively, the terminal device 20 transmits a communicative connection establishment request to the aircraft 10, the aircraft 10 returns a communicative connection response when receiving the communicative connection request, and the terminal device 20 establishes a communicative connection to the aircraft 10 when receiving the communicative connection response.

After the aircraft 10 establishes a communicative connection to the terminal device 20, the aircraft 10 transmits, by using the signal transceiver, the image collected by the camera apparatus 102 to the terminal device 20, and the terminal device 20 receives the image transmitted by the camera apparatus 102 and displays the image on the display 203 of the terminal device 20, so that the user can intuitively learn, from the display 203, the image acquired by the camera apparatus 102.

Step S103: Detect whether an instruction transmitted by the terminal device is received, the instruction being generated according to an operation performed by a user on the terminal device.

The aircraft 10 detects whether the instruction transmitted by the terminal device 20 is received, the instruction being generated according to an operation performed by the user on the terminal device 20.

The user views and analyzes the image displayed on the display 203, to determine whether a display effect of the image achieves a desired effect. The display effect of the image may be embodied by a clarity, a brightness and the like of the image.

When the image display effect displayed on the display 203 does not satisfy requirements of the user, the user transmits an instruction to the aircraft 10 by using the input apparatus 201 of the terminal device 20. The instruction is an adjustment instruction. The input apparatus 201 may be a remote control, a keyboard, a mouse, a touch panel or a knob switch.

Step S104: Adjust the dimming assembly according to the instruction if the aircraft receives the instruction to change the light entering the camera, so as to adjust the image.

If the aircraft 10 receives the instruction from the terminal device 20, the aircraft 10 adjusts the dimming assembly 1024 according to the instruction to change the light entering the camera 1021, so as to adjust the image collected by the camera apparatus 102 by using the camera 1021. The instruction is an adjustment instruction to adjust the dimming assembly 1024. The aircraft 10 controls, according to the adjustment instruction, the driver 1122 to adjust relative positions of the dimmer 1123 and the camera 1021, so as to adjust the light entering the camera 1021.

Step S104 specifically includes controlling the driver 1122 to drive the dimmer 1123 to rotate relative to the camera 1021 by a preset angle, to adjust the relative positions of the dimmer 1123 and the camera 1021, so as to change the light entering the camera 1021, thereby adjusting the image acquired by the camera 1021, if the adjustment instruction is received.

The controlling the driver to drive the dimmer to rotate relative to the camera by a preset angle further includes: after the aircraft 10 receives the adjustment instruction from the terminal device 20, outputting, by the aircraft 10, a pulse signal to the driver 1122, to control the driver 1122 to rotate according to the pulse signal, and rotate the dimmer 1121 by the preset angle. The preset angle is determined according to the pulse signal.

More specifically, when the aircraft 10 receives an adjustment instruction, the aircraft may generate a corresponding driving signal for adjusting the driver 1122, and adjust operations of the driver 1122 by controlling the driving signal of the driver 1122.

The driving signal of the driver 1122 may be a pulse signal or a current signal, that is, the driver 1122 is controlled by setting a magnitude of the current signal or a frequency of the pulse signal. In this embodiment, the driver 1122 is controlled to rotate by using the driving signal of the control driver 1122, for example.

Exemplarily, the adjustment instruction inputted by the user in the terminal device 20 is a pulse setting instruction and is transmitted by the terminal device 20 to the aircraft 10. The pulse setting instruction is used for the outputted pulse signal of the aircraft 10. The aircraft 10 has a correspondence preset therein between a rotation angle of the dimmer and a corresponding pulse frequency. After the aircraft 10 receives the pulse setting instruction, the aircraft adjusts a pulse frequency of the driver 1122 according to the pulse setting instruction, so that the preset angle can be adjusted.

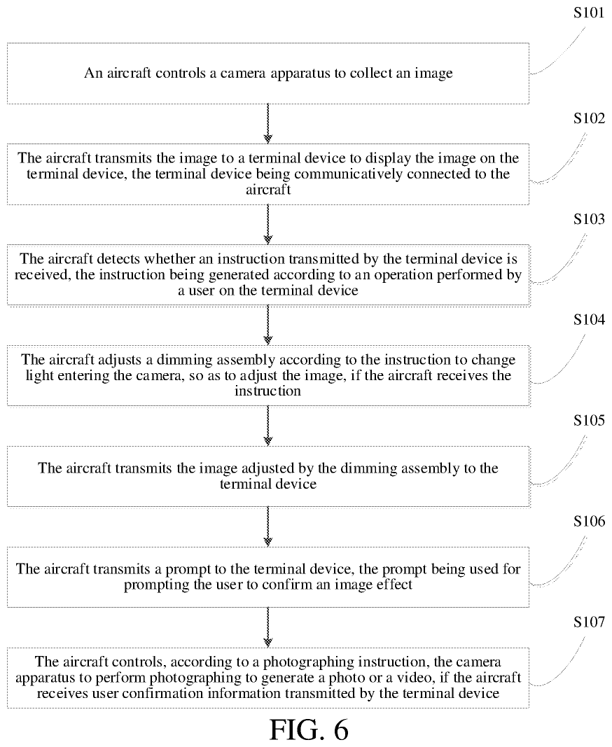

Referring to FIG. 6, in some embodiments, the instruction transmitted by the terminal device that is received by the aircraft further includes a photographing instruction, and the method further includes steps S105-S107 after step S104.

Step S105: Transmit the image adjusted by the dimming assembly to the terminal device.

The aircraft 10 transmits the image obtained after the light entering the camera 1021 is adjusted by the dimming assembly 1024 to the terminal device 20, so that the user may intuitively view, on the display 203 of the terminal device 20, an image effect adjusted by the dimming assembly 1024.

Step S106: Transmit a prompt to the terminal device, the prompt being used for prompting the user to confirm an image effect.

The aircraft 10 transmits the image obtained after the light entering the camera 1021 is adjusted by the dimming assembly 1024 together with the prompt about the confirmation of the image effect to the terminal device 20, so that the user returns confirmation information in time when the image effect adjusted by the dimming assembly 1024 that is viewed by the user on the display 203 of the terminal device 20 satisfies the requirements of the user. The prompt may be a voice, a flashlight alarm or a pop-up message, which is not limited herein.

Step S107: Control, according to the photographing instruction, the camera apparatus to perform photographing to generate a photo or a video, if the aircraft receives user confirmation information transmitted by the terminal device.

When the user determines that the image effect satisfies the requirements, the user transmits the confirmation information to the aircraft 10 by controlling the terminal device 20, and the aircraft 10 generates a photographing instruction according to the confirmation information, to control the camera apparatus 102 to perform photographing to generate a photo or a video.

The generated photo and video may be stored in a memory configured in the camera apparatus 102, or may be stored in a memory configured in the terminal device 20, or may be stored in a server (not shown) connected to the terminal device 20 or the camera apparatus 102, which is not limited herein.

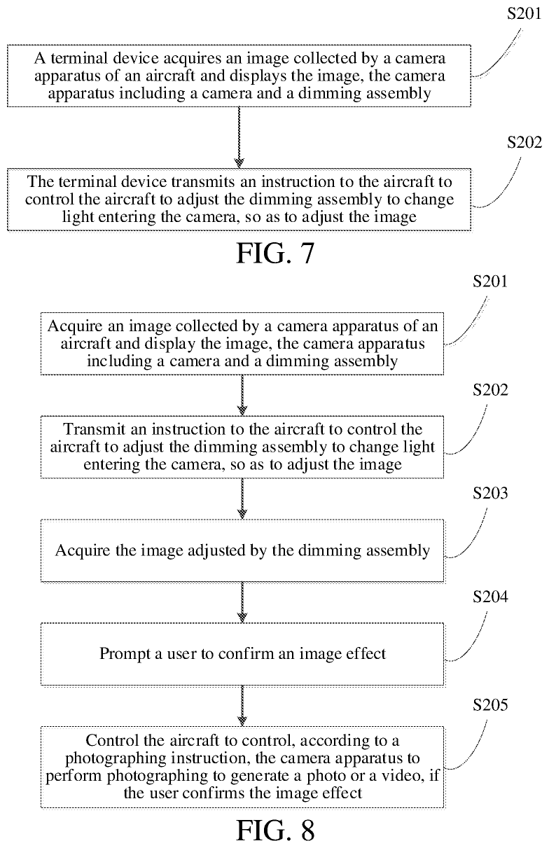

Referring to FIG. 7, FIG. 7 is a photographing method for an aircraft according to an embodiment of the present invention. The photographing method is applicable to the terminal device 20. A computer-executable program corresponding to the photographing method may be stored in the first memory 204 of the terminal device 20. When the first processor 205 of the terminal device 20 invokes the program of the photographing method stored in the first memory 201, the photographing method is performed.

The photographing method includes steps S201-S202.

Step S201: Acquire the image collected by the camera apparatus of the aircraft, and display the image, the camera apparatus including the camera and the dimming assembly.

After the terminal device 20 establishes a communicative connection to the aircraft 10, the terminal device 20 acquires the image collected by the camera apparatus 102 of the aircraft 10, and displays the image on the display 203 of the terminal device 20. The camera apparatus 102 includes the camera 1021 and the dimming assembly 1024.

Step S202: Transmit the instruction to the aircraft, to control the aircraft to adjust the dimming assembly to change the light entering the camera, so as to adjust the image.

The terminal device 20 transmits an instruction to the aircraft 10. The instruction is an adjustment instruction transmitted by the user by controlling the terminal device 20. The adjustment instruction is used for controlling the aircraft 10 to adjust the dimming assembly, to change the light entering the camera, so as to adjust the image.

The instruction includes an adjustment instruction to adjust the dimming assembly, and the dimming assembly includes a dimmer and a driver configured to drive the dimmer to rotate relative to the camera. The transmitting the instruction to the aircraft, to control the aircraft to adjust the dimming assembly to change the light entering the camera, so as to adjust the image includes: transmitting, by the terminal device 20, the instruction to the aircraft 10, to control the driver 1122 to drive the dimmer 1123 to rotate relative to the camera 1121 by a preset angle.

In some embodiments, the transmitting the instruction to the aircraft, to control the driver to drive the dimmer to rotate relative to the camera by a preset angle includes: controlling, by the terminal device 20, the aircraft 10 to output a pulse signal to the driver 1122, to control the driver 1122 to rotate according to the pulse signal, and rotate the dimmer 1121 by the preset angle.

Specifically, the adjustment instruction is a pulse setting instruction, and the terminal device 20 transmits the pulse setting instruction to the aircraft 10, so that the aircraft 10 adjusts a frequency of the outputted pulse signal according to the pulse setting instruction, to control the outputted pulse signal.

Referring to FIG. 8, after step S202, the photographing method further includes steps S203-S205.

Step S203: Acquire the image adjusted by the dimming assembly.

The terminal device 20 obtains the image adjusted by the dimming assembly 1024 that is transmitted by the aircraft 10 and displays the adjusted image on the display 203 of the terminal device 20.

Step S204: Prompt a user to confirm an image effect.

The aircraft 10 transmits the image adjusted by the dimming assembly 1024 together with a prompt message to the terminal device 20, to prompt the user to confirm the image effect.

Step S205: Control the aircraft to control, according to the photographing instruction, the camera apparatus to perform photographing to generate a photo or a video, if the user confirms the image effect.

If the terminal device 20 receives confirmation information from the user, the terminal device transmits a photographing instruction to the aircraft 10. The aircraft 10 receives the photographing instruction, and controls the photographing apparatus to perform photographing to generate a photo or a video.

The foregoing embodiments are merely preferred implementations of the present invention, and cannot be used to limit the protection scope of the present invention. Any insubstantial change and substitution made by those skilled in the art based on the present invention belongs to the protection scope required by the present invention.

What is claimed is:

1. A photographing method for an aircraft, applicable to an aircraft, the aircraft comprising a camera apparatus, the camera apparatus comprising a camera and a dimming assembly configured to adjust light entering the camera, and the photographing method comprising:
controlling the camera apparatus to collect an image;
transmitting the image to a terminal device to display the image on the terminal device, the terminal device being communicatively connected to the aircraft;
detecting whether an instruction transmitted by the terminal device is received, the instruction being generated according to an operation performed by a user on the terminal device; and
adjusting the dimming assembly according to the instruction to change the light entering the camera, so as to adjust the image, if the instruction is received.

2. The photographing method according to claim 1, wherein the instruction comprises an adjustment instruction to adjust the dimming assembly, and the dimming assembly comprises a dimmer and a driver configured to drive the dimmer to rotate relative to the camera; and
the adjusting the dimming assembly according to the instruction to change the light entering the camera, so as to adjust the image further comprises:
controlling the driver to drive the dimmer to rotate relative to the camera by a preset angle, if the adjustment instruction transmitted by the terminal device is received.

3. The photographing method according to claim 2, wherein the controlling the driver to drive the dimmer to rotate relative to the camera by a preset angle further comprises:
outputting a pulse signal to the driver to control the driver to rotate according to the pulse signal and rotate the dimmer by the preset angle.

4. The photographing method according to claim 3, wherein the adjustment instruction is a pulse setting instruction, and the photographing method further comprises:
acquiring a pulse setting instruction transmitted from the terminal device; and
adjusting a frequency of the outputted pulse signal according to the pulse setting instruction to control the outputted pulse signal.

5. The photographing method according to claim 1, wherein the instruction comprises a photographing instruction, and the method further comprises:
transmitting the image adjusted by the dimming assembly to the terminal device;
transmitting a prompt to the terminal device, the prompt being used for prompting the user to confirm an image effect; and
controlling, according to the photographing instruction, the camera apparatus to perform photographing to generate a photo or a video, if the aircraft receives user confirmation information transmitted by the terminal device.

6. A photographing method, applicable to a terminal device, the terminal device being configured to control an aircraft and being communicatively connected to the aircraft, and the photographing method comprising:
acquiring an image collected by a camera apparatus of the aircraft, and displaying the image, the camera apparatus comprising a camera and a dimming assembly; and
transmitting an instruction to the aircraft to control the aircraft to adjust the dimming assembly to change light entering the camera, so as to adjust the image.

7. The photographing method according to claim 6, wherein the instruction comprises an adjustment instruction to adjust the dimming assembly, and the dimming assembly comprises a dimmer and a driver configured to drive the dimmer to rotate relative to the camera; and
the transmitting an instruction to the aircraft to control the aircraft to adjust the dimming assembly to change light entering the camera, so as to adjust the image comprises:
transmitting the instruction to the aircraft to control the driver to drive the dimmer to rotate relative to the camera by a preset angle.

8. The photographing method according to claim 7, wherein the transmitting the instruction to the aircraft to control the driver to drive the dimmer to rotate relative to the camera by a preset angle comprises:
controlling the aircraft to output a pulse signal to the driver to control the driver to rotate according to the pulse signal and rotate the dimmer by the preset angle.

9. The photographing method according to claim 8, wherein the adjustment instruction is a pulse setting instruction, and the photographing method further comprises:
transmitting the pulse setting instruction to the aircraft, so that the aircraft adjusts a frequency of the outputted pulse signal according to the pulse setting instruction to control the outputted pulse signal.

10. The photographing method according to claim 6, further comprising:
acquiring the image adjusted by the dimming assembly;
prompting a user to confirm an image effect; and
controlling the aircraft to control, according to the photographing instruction, the camera apparatus to perform photographing to generate a photo or a video, if the user confirms the image effect.

11. An aircraft, communicatively connected to a terminal device, the aircraft comprising:
a camera apparatus, comprising a camera configured to collect an image and a dimming assembly configured to adjust light entering the camera;
a signal transceiver, configured to receive an instruction from the terminal device;
a memory, configured to store a computer-executable photographing method program; and
a processor, configured to invoke the computer-executable photographing method program to:
control the camera apparatus to collect an image;
transmit the image to a terminal device to display the image on the terminal device, the terminal device being communicatively connected to the aircraft;
detect whether an instruction transmitted by the terminal device is received, the instruction being generated according to an operation performed by a user on the terminal device; and
adjust the dimming assembly according to the instruction to change the light entering the camera, so as to adjust the image, if the instruction is received.

12. A terminal device, communicatively connected to an aircraft, the aircraft comprising a camera apparatus and a dimming assembly, the camera apparatus comprising a camera configured to collect an image, the dimming assembly being configured to adjust light entering the camera, and the terminal device comprising:
a display, configured to display the image collected by the aircraft;
an input apparatus, configured to input an instruction to the aircraft to control the aircraft to adjust the dimming assembly to change the light entering the camera, so as to adjust the image;
a memory, configured to store a computer-executable photographing method program; and
a processor, configured to invoke the computer-executable photographing method program to:
acquire an image collected by a camera apparatus of the aircraft, and displaying the image, the camera apparatus comprising a camera and a dimming assembly; and
transmit an instruction to the aircraft to control the aircraft to adjust the dimming assembly to change light entering the camera, so as to adjust the image.

13. A flight system, comprising a terminal device and an aircraft communicatively connected to the terminal device, the aircraft comprising:
a camera apparatus, comprising a camera configured to collect an image and a dimming assembly configured to adjust light entering the camera;
a signal transceiver, configured to receive an instruction from the terminal device;
a memory, configured to store a computer-executable photographing method program; and
a processor, configured to invoke the computer-executable photographing method program to:
control the camera apparatus to collect an image;
transmit the image to a terminal device to display the image on the terminal device, the terminal device being communicatively connected to the aircraft;
detect whether an instruction transmitted by the terminal device is received, the instruction being generated according to an operation performed by a user on the terminal device; and
adjust the dimming assembly according to the instruction to change the light entering the camera, so as to adjust the image, if the instruction is received.
